(19) United States
(12) Patent Application Publication
(10) Pub. No.: US 2016/0161988 A1
(43) Pub. Date: Jun. 9, 2016

(54) ADJUSTABLE TABLET CASE

(71) Applicant: Aevoe Corp., San Francisco, CA (US)

(72) Inventors: Steven REYMOND, San Francisco, CA (US); Tzu-Ching SHAO, Taipei (TW); Huai-Shun CHIANG, New Taipei City (TW); Cheng-Wei YAO, Taipei City (TW)

(21) Appl. No.: 14/562,330

(22) Filed: Dec. 5, 2014

(51) Int. Cl. G06F 1/16

(52) U.S. Cl. CPC G06F 1/1626; G06F 1/1618

(57) ABSTRACT

An adjustable tablet case for protecting tablet computers of different sizes is disclosed. The adjustable tablet case can include a foldable cover coupled to a tablet holding portion which has a central base portion. The adjustable table case can further include retention arms having retention regions. The retention arms resiliently can be coupled to the central base portion. The retention regions can be configured to retainingly receive an edge portion of a tablet computer. The retention portions and retention regions can be urged toward the central base portion by an urging mechanism and be capable of being at least partially extended away from the central base portion, thereby enabling the adjustable tablet case to receive and protect tablets of varying size.

### FIELD

The subject matter herein generally relates to a tablet cases. More specifically, the subject matter herein relates to a tablet case that can be adjusted for tablets of different sizes.

### BACKGROUND

Cases for tablets are used to prevent the screen from being scratched or damaged. While using the tablet, the user may want to have the tablet propped up so the user does not have to hold the tablet the entire time. Furthermore, tablets come in a variety of sizes, so one case often only fits a specific tablet. If the user obtains a new tablet, the user would most likely also need a new case.

### BRIEF DESCRIPTION OF THE DRAWINGS

Implementations of the present technology will now be described, by way of example only, with reference to the attached figures.

FIG. 1 is an isometric view of one embodiment of an adjustable tablet case supporting a tablet in a propped position.

FIG. 2 is a diagrammatic view of one embodiment of an adjustable tablet case wherein retention portions thereof are not extended.

FIG. 3 is a diagrammatic view of one embodiment of an adjustable tablet case where the retention portions are extended.

FIG. 4 is a diagrammatic view of one embodiment of a tablet holding portion of an adjustable tablet case where the retention portions are extended.

FIG. 5 is a diagrammatic view of one embodiment of a tablet holding portion of an adjustable tablet case where the retention portions are not extended.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The present disclosure is described in relation to a case that adjusts to accommodate a variety of tablet sizes.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially rectangular means that the object in question resembles a rectangle, but can have one or more deviations from a true rectangle.

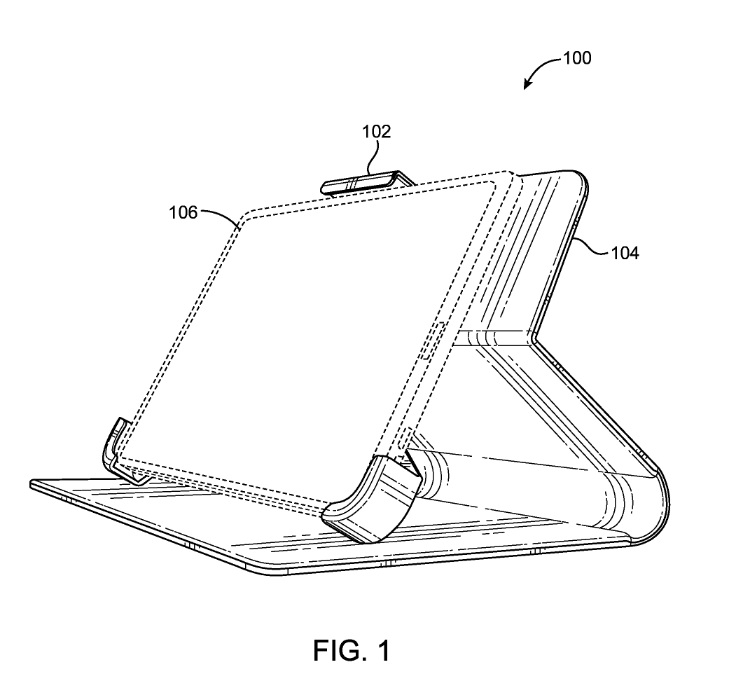

FIG. 1 illustrates an adjustable tablet case 100 holding a tablet 106 in a propped position. The adjustable tablet case 100 includes a cover 104 which can be used to partially of substantially completely envelope a tablet 106. The cover 104 can be adjusted to act as a stand for the tablet 106. The cover 104 can be adjusted to be a case for the tablet 106, with the cover 104 protecting the screen of the tablet 106. The adjustable tablet case 100 can include a tablet holding portion 102 that can be used to releasably fasten the tablet 106 to the cover 104. When the tablet holding portion 102 is fastened to the tablet 106, (as during normal operation) the tablet 106 can be effectively secured to (and within) the adjustable tablet case 100.

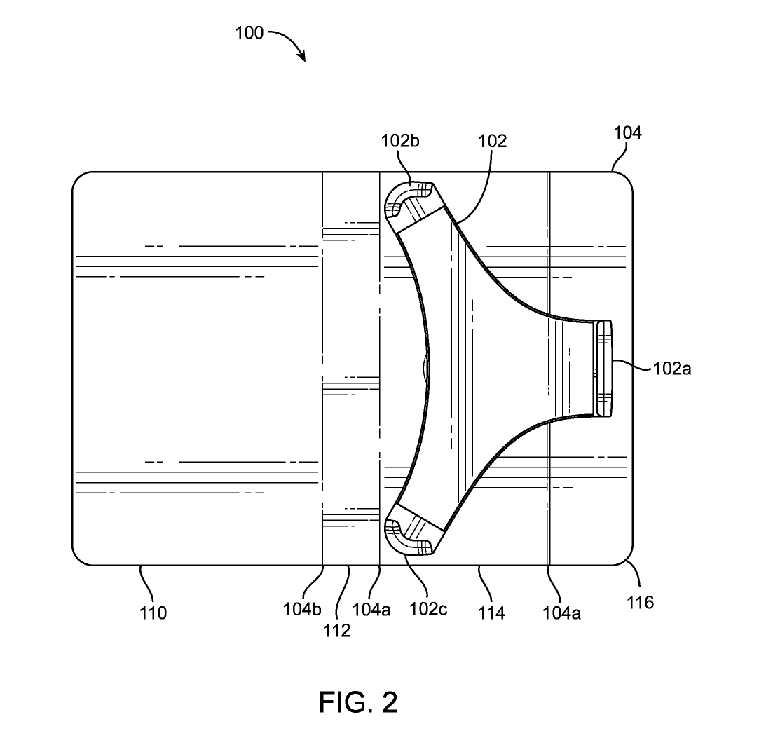

FIG. 2 illustrates a diagrammatic view of one embodiment of the adjustable tablet case 100 where the retention portions 102a, 102b, 102c are not extended. In at least one embodiment, the retention portions can be partially arcuate shaped to receive a portion of a tablet 106, such as a corner of the tablet (see 102b and 102c), or substantially flat to receive a portion of a side region of a tablet (see 102a). Thus for example, retention portion 102a can be used to couplingly receive a side of the tablet 106. The corner retention portions 102b, 102c can be used to couplingly receive the corners of the tablet 106 opposite the side of the tablet 106 received by retention portion 102a. Accordingly, a region of the retention portion102a can be substantially flat to conform to the side of the tablet 106. Additionally, the corner retention portions 102b, 102c can be substantially curved to conform to the corners of the tablet 106.

The cover 104 can include a top cover section 116. The top cover section 116 can be proximate retention portion 102a of the tablet holding portion 102 during normal use. The top cover section 116 can be form a subsection of the cover 104. The top cover section 116 can be separated from the remainder of the cover 104 by a fold 104a in the cover imposed during manufacture. The cover 104 can also include a rear cover section 114 and a front cover section 110. The rear cover section 114 along with the top cover section 116 can protect the rear of the tablet 106. The rear cover section can be defined by rear cover folds 104a. One rear cover fold 104a separates the top cover section 116 and the rear cover section 114, as discussed above. The rear cover folds 104a allow the cover 104 to be adjusted in form from a flat and closed position to a propped position (as shown in FIG. 1). The cover 104 can include a cover spine 112 that can be defined by a rear cover fold 104a and a front cover fold 104b. The cover spine 112 can connect the front cover section 110 and the rear cover section 114. The cover spine 112 can bend to form substantially an arch. The cover spine 112 can also lay substantially flat. The front cover section 110 can protect the screen of the tablet 106 when the adjustable tablet case 100 is closed. The front cover section 110 can act as a base when the adjustable tablet case 100 is in a propped position (as shown in FIG. 1).

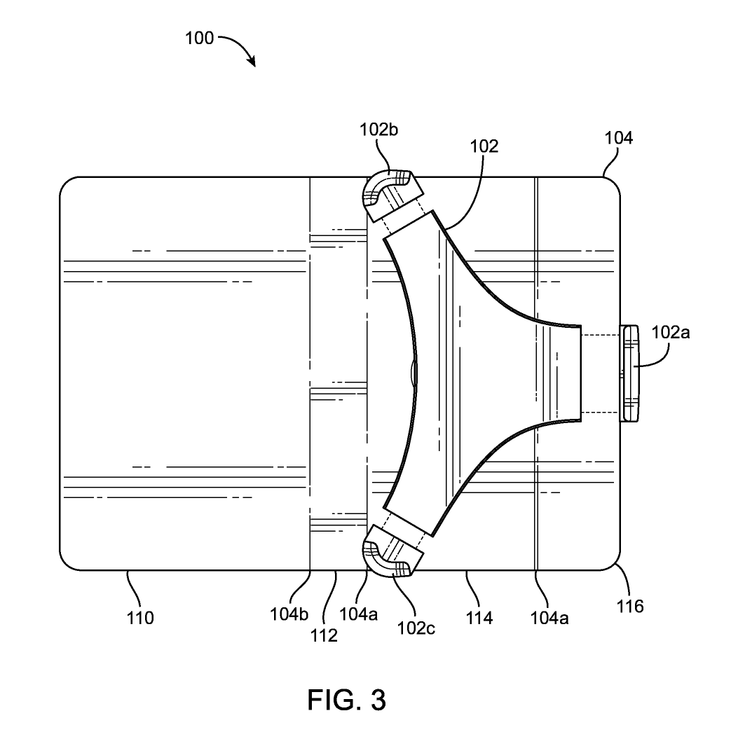

FIG. 3 illustrates a diagrammatic view of one embodiment of the adjustable tablet case 100 where the retention portions 102a, 102b, 102c are extended. The retention portions 102a, 102b, 102c can be extended to conform to different sized tablets 106. The retention portion 102a can extend to fasten to a side of the tablet 106. In at least one embodiment, the retention portion 102a can extend further than the outside edge of the top cover section 116. In other embodiments, the retention portion 102a can extend to the outside edge of the top cover section 116. The corner retention portions 102b, 102c fasten to the corners of the tablet 106 opposite the side that the retention portion 102a is fastened. In at least one embodiment, the corner retention portions 102b, 102c can extend further than the edges of the cover 104. In other embodiments, the corner retention portions 102b, 102c can extend to the outside edges of the cover 104.

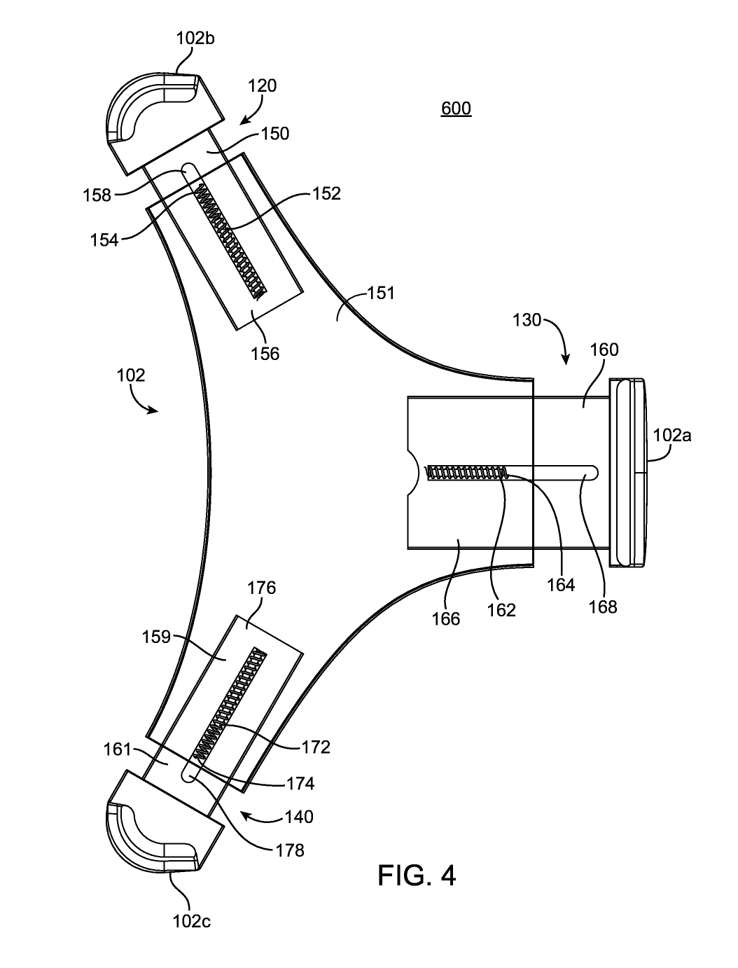

FIG. 4 illustrates a tablet holding portion 102 in an expanded state 600 where the retention portions 102a, 102b, 102c are extended. When the retention portions 102a, 102b, and 102c are extended, expansion regions 120, 130, 140 are present. Expansion regions 120, 130, 140 can be the region between the retention portions 102a, 102b, 102c and the base 151 of the tablet holding portion 102. Side expansion region 130 can correspond to the retention portion 102a. Corner expansion regions 120, 140 can correspond to the corner retention portions 102b, 102c. The tablet holding portion 102 can include a side expansion arm 160 and corner expansion arms 150 and 161 that correspond to the retention portion 102a and the corner retention portions 102b, 102c, respectively. Expansion arms 150, 160 and 161 can be resiliently coupled to the central portion 151 of the tablet holding portion 104. When the retention portions 102a, 102b, 102c are extended, parts of the expansion 150, 160 and 161 are exposed, forming expansion regions 120, 130 and 140, respectively. Expansion arms 150, 160 and 161 can be partially or wholly received within arm receiving regions 156, 166 and 159, respectively. The exposed base portions 150, 160, 161 can provide support and maintain the structural integrity of the tablet holding portion 102 when the tablet holding portion 102 is expanded. As such, the tablet holding portion 102 can be adjusted to accommodate a variety of tablet 106 sizes. The expansion bases 166, 156, 176 can include spaces 168, 158, 178. Rods 162, 152, 172 can be attached to the expansion bases 166, 156, 176 inside the spaces 168, 158, 178. The rods 162, 152, 172 can be attached to the expansion bases 166, 156, 176 proximate to the central region 151 of the tablet holding portion 102. Springs 164, 154, 174 act as an urging mechanism and can be coupled to the rods 162, 152, 172. Other urging mechanisms can be used, for example elastic bands or the like. The rods are received within the springs and impose a resilient force on the arms 150, 160, 161, urging the arms 150, 160, 161 towards the central region 151 of the tablet holding portion 102. The arms thus need to be manually drawn out and away from the central region 151 to couple with a tablet 106. The force imposed by the springs or other suitable mechanism urges the coupled sides of the tablet 106 inward towards the central region, thereby enabling the tablet 106 to be releasably retained within the case 100.

In at least one embodiment, when the retention portions 102a, 102b, 102c are extended, the springs 164, 154, 174, are compressed. When the retention portions 102a, 102b, 102c are released, the springs 164, 154, 174 expand and retract the retention portions 102a, 102b, 102c toward the center of the tablet holding portion 102. A tablet 106 can be inserted while the retention portions102a, 102b, 102c are extended. When the retention portions 102a, 102b, 102c are retracted by the springs 164, 154, 174, the retention portions 102a, 102b, 102c fasten to and secure the tablet 106.

In other embodiments, when the retention portions 102a, 102b, 102c are extended, the springs 164, 154, 174 are stretched. When the retention portions 102a, 102b, 102c are released, the springs 164, 154, 174 retract and pull the retention portions 102a, 102b, 102c toward the center of the tablet holding portion 102. A tablet 106 is inserted while the retention portions 102a, 102b, 102c are extended. When the retention portions 102a, 102b, 102c are retracted by the springs 164, 154, 174, the retention portions 102a, 102b, 102c fasten to and secure the tablet 106.

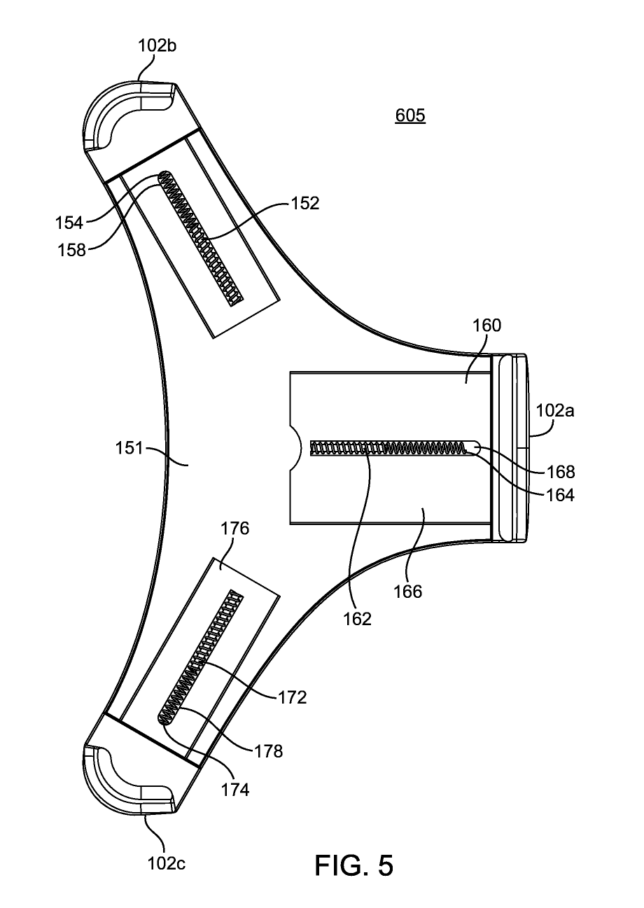

FIG. 5 illustrates one embodiment of a tablet holding portion 102 in a retracted state 605 where the retention portions 102a, 102b, 102c are not extended. When the tablet holding portion 102 is in a retracted state 605, the springs 164, 154, 174 are at a neutral state. The expansion regions 120, 130, 140 are not present, and the expansion bases 166, 156, 176 can be fully retracted into the tablet holding portion 102. In the retracted state 605, the springs 164, 154, 174 can substantially fill the entirety of the spaces 168, 158, 178.

Other configurations of the claimed subject matter will be apparent to one of skill in the art. For example, the side retaining portion 102a could be replaced with two corner retention portions, like 102b and 102c. Alternatively, four side retention portions like that of 102a could be provided. Thus, the embodiments shown and described above are only examples.

Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the following claims.

We claim:

1. An adjustable tablet case for protecting tablet computers of different sizes, the adjustable tablet case comprising:
a foldable cover coupled to a tablet holding portion, the tablet holding portion having a central base portion;
at least three retention arms having retention regions, the retention arms resiliently coupled to the central base portion, the retention regions configured to retainingly receive an edge portion of a tablet computer,
wherein the retention portions and retention regions are each urged toward the central base portion by an urging mechanism and are capable of being at least partially extended away from the central base portion, thereby enabling the adjustable tablet case to receive and protect tablets of varying size.

2. The adjustable tablet computer of claim 1, wherein the tablet holding portion is rotatably adjustable with regard to the foldable cover.

3. The adjustable tablet case of claim 2, wherein the urging mechanism comprises a spring.

4. The adjustable tablet case of claim 3, wherein the spring is preloaded to a have predetermined spring constant.

5. The adjustable tablet case of claim 3, wherein each of the retention portions comprises a post and the spring is received therein.

6. The adjustable tablet case of claim 3, wherein the spring is composed primarily of stainless steel.

7. The adjustable tablet case of claim 1, wherein the retention regions are at least partially arcuate shaped.

8. The adjustable tablet case of claim 1, wherein each of the retention portions has a lip formed thereon, suitably shaped to partially encase a front region of the tablet.

9. The adjustable tablet case of claim 1, wherein the foldable cover is configurable to at least partially envelope the tablet.

10. The adjustable tablet case of claim 9, wherein the foldable cover is further configurable to be folded to serve as a stand for the tablet.

11. An adjustable tablet case for protecting tablet computers of different sizes, the adjustable tablet case comprising:
a foldable cover coupled to a tablet holding portion, the tablet holding portion having a central base portion; and
at least three retention arms having retention regions, the retention arms being translatable between a retracted configuration in which the retention regions are proximate the central base portion, and an expanded configuration in which the retention regions are spaced a distance from the central base portion;
wherein the retention regions are resiliently urged towards the central base portion.

12. The adjustable tablet computer of claim 9, wherein the tablet holding portion is rotatably adjustable with regard to the foldable cover.

13. The adjustable tablet case of claim 11, wherein the retention portions are each resiliently urged by a spring.

14. The adjustable tablet case of claim 12, wherein the spring is preloaded to a have predetermined spring constant.

15. The adjustable tablet case of claim 12, wherein each of the retention portions comprises a post and the spring is received therein.

16. The adjustable tablet case of claim 12, wherein the spring is composed primarily of stainless steel.

17. The adjustable tablet case of claim 9, wherein the retention regions are at least partially arcuate shaped.

18. The adjustable tablet case of claim 9, wherein each of the retention portions has a lip formed thereon, suitably shaped to partially encase a front region of the tablet.

19. The adjustable tablet case of claim 9, wherein the foldable cover is configurable to at least partially envelope the tablet.

20. The adjustable tablet case of claim 18, wherein the foldable cover is further configurable to be folded to serve as a stand for the tablet.
